(19) United States
(12) Patent Application Publication
(10) Pub. No.: US 2016/0076489 A1
(43) Pub. Date: Mar. 17, 2016

(54) EXHAUST GAS HEAT EXCHANGER

(71) Applicant: MAHLE International GmbH, Stuttgart (DE)

(72) Inventors: Oliver GRILL, Moetzingen (DE); Helmut WEISER, Tuebingen (DE)

(73) Assignee: MAHLE International GmbH, Stuttgart (DE)

(21) Appl. No.: 14/949,334

(22) Filed: Nov. 23, 2015

Related U.S. Application Data
(63) Continuation of application No. PCT/EP2014/060510, filed on May 22, 2014.

(30) Foreign Application Priority Data
May 23, 2013 (DE) 10 2013 209 617.8

(51) Int. Cl. F02M 25/07; F28F 21/06; F28D 7/10

(52) U.S. Cl. CPC F02M 25/0734; F28D 7/106; F28F 21/062

(57) ABSTRACT

An exhaust-gas heat exchanger having a housing and a first flow channel. The first flow channel is accommodated in the housing in such a way that a second flow channel is formed between the first flow channel and the housing. A first fluid can flow through the first flow channel and a second fluid can flow through the second flow channel. The second fluid can flow around the first flow channel. The housing has a first diffuser and a second diffuser at an end of the housing and at least one of the diffusers is made of a plastic.

This nonprovisional application is a continuation of International Application No. PCT/EP2014/060510, which was filed on May 22, 2014, and which claims priority to German Patent Application No. 10 2013 209 617.8, which was filed in Germany on May 23, 2013, and which are both herein incorporated by reference.

### BACKGROUND OF THE INVENTION

1. Field of the Invention

The present invention relates to an exhaust gas heat exchanger comprising a housing and comprising a first flow channel, wherein the first flow channel can be accommodated in the housing in such a way that a second flow channel can be formed between the first flow channel and the housing, wherein a first fluid may flow through the first flow channel, and a second fluid may flow through the second flow channel, wherein the second fluid may flow around the first flow channel. The housing can have a first diffuser and a second diffuser on an end.

2. Description of the Background Art

Exhaust gas recirculation is used for the purpose of further reducing the emission values in modern internal combustion engines. For this purpose, the exhaust gas flowing out of the internal combustion engine after combustion is first conducted through a heat exchanger for cooling and is then fed back to the internal combustion engine. The temperature in the combustion chamber and the development of emissions are reduced thereby.

A wide range of approaches are known in the conventional art, which provide, among other things, different exhaust gas heat exchangers made of high grade steel and/or aluminum. These include, for example, tube bundle heat exchangers, or heat exchangers produced in a stacked plate design. A transfer of heat from the hot exhaust gas to a coolant is produced in the heat exchanger.

The disadvantage of the approaches according to the conventional art is, in particular, that high grade steel and aluminum are regularly used as materials for the heat exchangers. High grade steel is cost-intensive, heavy and has limitations with regard to its shaping capabilities, which result, among other things, from the particular manufacturing method selected. Aluminum is unusable in corrosive environments, due to its material properties.

### SUMMARY OF THE INVENTION

It is therefore an object of the present invention to provide an exhaust gas heat exchanger which is optimized with respect to the prior art and has a cost-effective design, a low weight and a high design freedom with regard to the shaping thereof.

An exemplary embodiment of the invention provides an exhaust gas heat exchanger comprising a housing and comprising a first flow channel, wherein the first flow channel is accommodated in the housing in such a way that a second flow channel is formed between the first flow channel and the housing, wherein a first fluid may flow through the first flow channel, and a second fluid may flow through the second flow channel, wherein the second fluid may flow around the first flow channel, wherein the housing has a first diffuser and a second diffuser on an end, wherein at least one of the diffusers is formed from a plastic.

The exhaust gas heat exchanger can be designed in the form of a tube bundle heat exchanger. A single or plurality of fluid-conducting tubes can be disposed within the housing in such a way that a second flow channel is formed between the tubes and the housing, through which a second fluid may flow. The fluid which flows through the tubes is regularly an exhaust gas from an internal combustion engine, and the second fluid, which flows through the second flow channel, is a coolant.

The tubes can be accommodated in tube sheets on the end, which close the housing and thus also the second flow channel on the end. The fluid can be supplied to the tubes or removed from the tubes via diffusers, which can be connected to the housing in such a way that a fluid-tight connection occurs between the diffuser and the tubes.

The housing furthermore can include a first fluid connection for supplying the second fluid to the second flow channel and a second flow connection for removing the second fluid from the second flow channel.

A diffuser manufactured from plastic is particularly advantageous, since its manufacture is much easier and more cost-effective than the manufacture of a diffuser from a metallic material. A plastic diffuser is also lighter in weight.

Moreover, it may be advantageous if the diffuser formed from plastic is at least partially formed from one or multiple of the materials polyamide (PA6) and/or polyamide (PA66) and/or polyphthalamide (PPA) and/or polyphenylene sulfide (PPS).

The specified plastics are characterized, in particular, by good workability and are also easy to obtain. In particular, they are furthermore resistant to corrosive media, which may occur, for example, in exhaust gas. In addition, the aforementioned plastics have a sufficiently high thermal stability to be able to be used in an exhaust gas heat exchanger. The impact resistance of the specified plastics is also advantageous in order to withstand mechanical effects without damage, for example due to dirt particular carried along in the exhaust gas.

It may also be expedient if the diffuser manufactured from plastic has a first opening and a second opening, wherein the first opening of the diffuser faces the housing and the second opening of the diffuser faces away from the housing.

In particular, a pipeline may be connected to the second opening, via which a fluid may flow into or out of the diffuser. The design of the diffuser makes it easier to connect a fluid-supplying or a fluid-discharging pipeline to the exhaust gas heat exchanger. Due to an adapted cross-sectional profile of the diffuser, a pipeline having a smaller diameter may be connected in this manner to the housing, which generally has a larger diameter than the pipeline. By providing the diffuser with a corresponding design, pipelines and a housing of different cross-sectional shapes may also be connected to each other.

It may furthermore be particularly advantageous if a circumferential, planar flange area is formed around the first opening, via which the diffuser is connectable to the housing.

The planar flange area advantageously runs in a plane which is perpendicular or substantially perpendicular to the main extension direction of the first flow channel in the housing. The diffuser can be connectable to the housing if the housing also has a circumferential flange of a comparable orientation.

In an embodiment, a sealing element may be provided between the diffuser and the housing, which is formed, for example, from an elastomer. The sealing element may be inserted between the diffuser and the housing or, for example, injection-molded onto the diffuser and/or the housing. Alternatively, a metal seal may also be provided, which is inserted between the diffuser and the housing.

An embodiment provides that the diffuser manufactured from plastic can have a deflection of the main flow direction of the fluid flowing through it between the first opening and the second opening by a predefinable angle, the deflection preferably taking place by an angle of 90°.

A particularly space-saving design of the exhaust gas heat exchanger may be achieved with the aid of a deflection of the flow direction of the fluid flowing through the diffuser. A deflection may take place, in principle, at any angle. In the dimensioning of the deflection, attention must be paid, in particular, to the pressure loss occurring as a result of the deflection.

In an embodiment of the invention, it may be provided that the diffuser manufactured from plastic can be designed as a module assembly, the module assembly having at least one supporting sleeve and/or a reinforcing element and/or a pressure plate and/or a sealing element.

A module assembly is advantageous, in particular, since the amount of effort during the mounting process may be reduced by the use of a module assembly. The premounting of the module assembly may be decoupled in time from the rest of the mounting process. In addition, a module assembly designed in this manner makes it possible to easily replace a diffuser manufactured from a metallic material with a diffuser manufactured from plastic.

A supporting sleeve can be, for example, a metallic ring which may be inserted into the second opening of the diffuser to create an additional supporting action against a clamping element, for example a hose clamp, and thus to support the diffuser manufactured from plastic.

A reinforcing element can be, for example, a sleeve which may be inserted into bores in the flange area of the diffuser to mitigate the clamping forces which are generated by screws during connection with the housing. Damage to the diffuser manufactured from plastic is to be avoided thereby.

A pressure plate can be, for example, a plastic plate or a metal plate, which is placed on the flange area of the diffuser and helps distribute single-point stresses generated by the screw connections evenly over the entire flange area. For this purpose, the pressure plate is designed in such a way that it has dimensions which essentially correspond to the flange area and has openings which correspond to the bores in the flange area.

An elastomer seal can be, for example, injection-molded onto the diffuser, glued thereto or connected thereto via other holding devices.

The diffuser manufactured from plastic may be manufactured in an injection molding process.

The injection molding process is advantageous, in particular, since a very high degree of design freedom exists for designing the diffuser.

In an embodiment of the invention, it is also provided that the diffuser manufactured from plastic can be connectable to the housing via a plurality of screw connections.

Screw connections are particularly advantageous, since they permit a very uniform and especially stress-resistant connection to be established. The connections may also be disconnected again without damage and may be adapted to a wide range of designs of the diffuser and in particular of the flange area.

The diffuser manufactured from plastic can have a plurality of rib elements on at least one of its outer surfaces, which increase the strength of the diffuser.

Rib elements on the outside of the diffuser are particularly advantageous for absorbing stress occurring in the interior of the diffuser as a result of the exhaust gas pressure. Due to an optimized design of the rib elements, an unwanted deformation of the diffuser during operation may be avoided, which is compatible with the durability of the diffuser.

The first diffuser can be formed from a metallic material and the second diffuser can be formed from a plastic, wherein the first fluid may be supplied to the first flow channel via the first diffuser and discharged from the first flow channel via the second diffuser.

In particular, the first diffuser, which is used to supply the first fluid, can be formed from a metallic material, since the first fluid is regularly an exhaust gas from an internal combustion engine. The temperature of the exhaust gas, which is not yet cooled, at the inlet of the exhaust gas heat exchanger may be too high for a diffuser manufactured from plastic. Only after the exhaust gas is cooled in the exhaust gas heat exchanger does the exhaust gas reliably have a temperature which is below the maximum limit temperature of the second diffuser manufactured from plastic. The limit temperature in this case is understood to be a temperature which is not critical for the structural integrity of the diffuser manufactured from plastic.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective external view of a diffuser manufactured from plastic, which is connected to a housing of an exhaust gas heat exchanger with the aid of multiple screw connections; and

FIG. 2 shows a sectional view of a diffuser according to the invention, made of plastic, which is connected to a housing of an exhaust gas heat exchanger.

### DETAILED DESCRIPTION

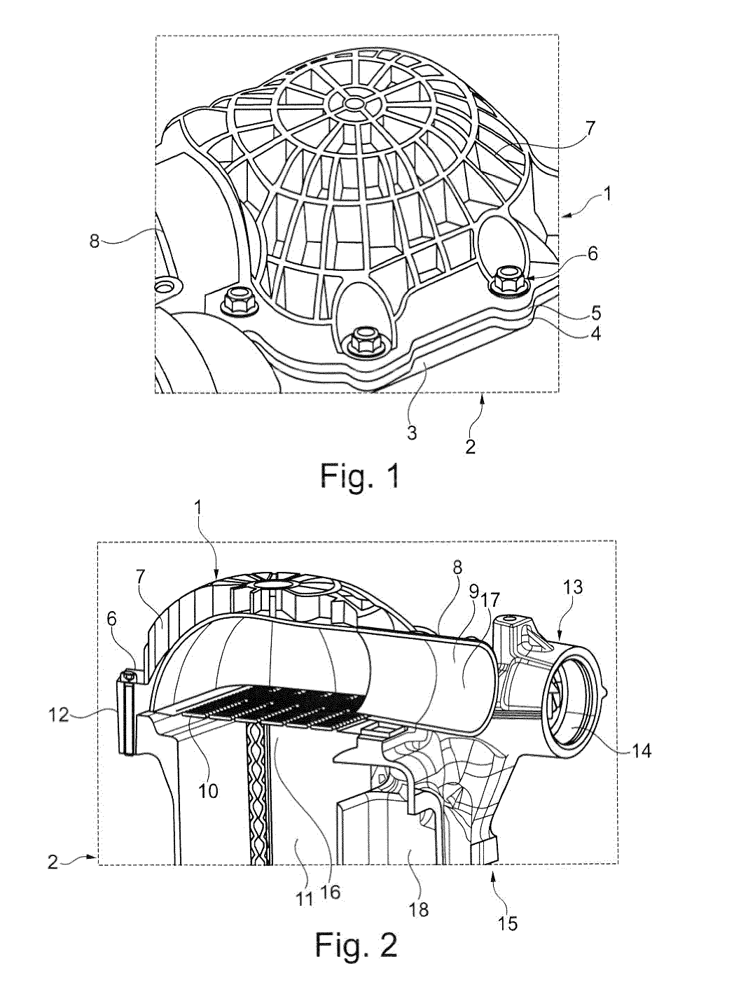

FIG. 1 shows a perspective view of a diffuser 1 manufactured from plastic. Diffuser 1 is mounted on a housing 2. For this purpose, housing 2 has a circumferential, planar flange area 3, to which diffuser 1 is connected via screw connections 6. A sealing element 4 and a pressure plate 5 are disposed between housing 2 and diffuser 1.

Sealing element 4 may be designed, for example, as an elastomer seal or as a metal seal. It may be inserted between diffuser 1 and housing 2 or injection-molded onto diffuser 1 or housing 2. Sealing element 4 is adapted to the dimensions of flange area 3 or to the flange area of diffuser 1 facing housing 2. Sealing element 4 has openings which correspond to screw connections 6. A holder, which simplify the positioning of sealing element 4, may be provided on diffuser 1 or housing 2. These may be, for example, tabs or projections which make it easier to insert or mount sealing element 4.

A pressure plate 5 is disposed above sealing element 4. This pressure plate 5 may be advantageously formed from a plastic or a metallic material. Pressure plate 5 is also adapted to flange area 3 or to the flange area of diffuser 1, which is not illustrated. Pressure plate 5 also has openings which correspond to screw connections 6. The purpose of pressure plate 5 is to transfer the single-point stresses caused by screw connections 6 evenly over a preferably large area of diffuser 1. This is intended to decrease single-point loads in favor of planar loads.

In one particularly preferred specific embodiment, it may be provided that pressure plate 5 and sealing element 4 are combined with diffuser 1 manufactured from plastic in a premounted module assembly. This facilitates, in particular, the mounting process of the exhaust gas heat exchanger.

Diffuser 1 has a plurality of rib elements 7 on its outer surface. These rib elements 7 run on the outer surface of diffuser 1 in such a way that the stresses which arise as a result of the exhaust gas pressure or similar variables in the interior of the exhaust gas heat exchanger may be reduced without significant deformations of diffuser 1.

FIG. 1 shows one embodiment of rib elements 7, wherein rib elements 7 run to a central midpoint on diffuser 1, starting from the flange area. Radially oriented rib elements 7 are supported by circumferential rib elements 7 of an essentially circular design.

Diffuser 1 has a dome-like shape, which is placed on housing 2.

The design of rib elements 7 may also be oriented, in particular, to the specific stresses occurring at diffuser 1. An orientation of rib elements 7 that deviates from the design illustrated in FIG. 1 may therefore also be provided.

A fluid connection 8 is shown in the left area of FIG. 1. This connection forms the fluid outlet of diffuser 1. The more exact structure of fluid connection 8 is explained in FIG. 2 below.

FIG. 2 shows a sectional view of diffuser 1 in FIG. 1. In FIG. 2, a detail of an exhaust gas heat exchanger 15 is illustrated as a whole, which comprises a housing 2 and diffuser 1 manufactured from plastic.

A flow channel 11 is formed within housing 2, through which a coolant advantageously flows. A tube sheet 10 is disposed between flow channel 11 and diffuser 1. Tubes may be inserted into this tube sheet 10, which are, however, not illustrated for reasons of clarity. Tube sheet 10 creates a fluid-tight separation between flow channel 11 and the interior of diffuser 1. As a result, no fluid communication exists between the interior of diffuser 1 and flow channel 11. The interior of diffuser 1 is in fluid communication with the inner area of the tubes, which are not illustrated. The tubes form the first flow channel, through which an exhaust gas advantageously flows. A coolant advantageously flows through flow channel 11 forming the second flow channel.

For this purpose, housing 2 has a fluid connection 13, via which a coolant may be introduced into housing 2. The coolant first flows into an area 18, which is disposed upstream from flow channel 11. This upstream area 18 is separated from flow channel 11 over a wide area of housing 2 by a partition wall projecting into housing 2. An overflow point between upstream area 18 and flow channel 11 is disposed in the upper area facing diffuser 1. A coolant flowing in or out via fluid connection 13 is able to flow between upstream area 18 and flow channel 11 via this point.

Fluid connection 13 has a supporting sleeve 14 in its interior, which is designed as an annular element. Supporting sleeve 14 is essentially used to increase the stability of fluid connection 13, which is advantageously manufactured from a plastic.

It is furthermore apparent in FIG. 2 that diffuser 1 has a first opening 16, which is disposed on the end of diffuser 1 facing flow channel 11. Diffuser 1 also has a second opening 17, which is disposed on the end area of fluid connection 8 of diffuser 1.

In one advantageous embodiment, an exhaust gas flows through the tubes, which are not illustrated, and is cooled in the area of housing 2 by the coolant flowing through flow channel 11. In its cooled form, the exhaust gas then flows out of exhaust gas heat exchanger 15 via diffuser 1. A flow path, which runs between first opening 16 and second opening 17, is formed for this purpose in the interior of diffuser 1.

Circular fluid connection 8 of diffuser 1 has a supporting sleeve 9 of an annular design in its end area. It is used to increase the stability of fluid connection 8. A pipeline, for example, may then be connected to fluid connection 8, which may be fastened to fluid connection 8, in particular, via a clamp, such as a hose clamp. Since fluid connection 8 is manufactured entirely from plastic, the stability of fluid connection 8 as a whole may be significantly increased with the aid of a supporting sleeve 9, which is advantageously manufactured from a metallic material.

Screw connections 6 are furthermore indicated in FIG. 2, which connect diffuser 1 to the circumferential flange area of housing 2 in a connecting area 12.

The dome-like shape of diffuser 1 is also apparent in FIG. 2. It is shown that a fluid, which flows through first opening 16 in diffuser 1 via the tubes, which are not illustrated, is deflected by approximately 90° before it flows out of diffuser 1 through fluid connection 8 via second opening 17. A particularly compact design of exhaust gas heat exchanger 15 may be achieved in this manner.

The exemplary embodiments illustrated in FIGS. 1 and 2 are examples and are not limiting in nature. In particular, the shaping of diffuser 1 or the arrangement of screw connections 6 or the design of connecting area 12 may deviate from the illustrated FIGS. 1 and 2 in alternative specific embodiments.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An exhaust gas heat exchanger comprising:
a housing; and
a first flow channel arranged in the housing such that a second flow channel is formed between the first flow channel and the housing,
wherein a first fluid is adapted to flow through the first flow channel and a second fluid is adapted to flow through the second flow channel,
wherein the second fluid may flow around the first flow channel,
wherein the housing has a first diffuser and a second diffuser on an end of the housing, and
wherein at least one of the first or second diffusers is formed from a plastic.

2. The exhaust gas heat exchanger according to claim 1, wherein the diffuser formed from plastic is at least partially formed from one or a combination of materials including: polyamide (PA6) and/or polyamide (PA66) and/or polyphthalamide (PPA) and/or polyphenylene sulfide (PPS).

3. The exhaust gas heat exchanger according to claim 1, wherein the diffuser manufactured from plastic has a first opening and a second opening, wherein the first opening of the diffuser faces the housing, and wherein the second opening of the diffuser faces away from the housing.

4. The exhaust gas heat exchanger according to claim 3, wherein a circumferential, planar flange area is formed around the first opening via which the diffuser is connectable to the housing.

5. The exhaust gas heat exchanger according to claim 3, wherein the diffuser manufactured from plastic has a deflection of the main flow direction of the fluid flowing through it between the first opening and the second opening by a predefinable angle, wherein the deflection preferably take place by an angle of 90°.

6. The exhaust gas heat exchanger according to claim 1, wherein the diffuser manufactured from plastic is designed as a module assembly, wherein the module assembly has at least one supporting sleeve and/or a reinforcing element and/or a pressure plate and/or a sealing element.

7. The exhaust gas heat exchanger according to claim 1, wherein the diffuser manufactured from plastic is be produced in an injection molding process.

8. The exhaust gas heat exchanger according to claim 1, wherein the diffuser manufactured from plastic is connectable to the housing via a plurality of screw connections.

9. The exhaust gas heat exchanger according to claim 1, wherein the diffuser manufactured from plastic has a plurality of rib elements on at least one of its outer surfaces, which increase the strength of the diffuser.

10. The exhaust gas heat exchanger according to claim 1, wherein the first diffuser is formed from a metallic material and the second diffuser is formed from a plastic, wherein the first fluid is supplied to the first flow channel via the first diffuser and discharged from the first flow channel via the second diffuser.
